(19) United States
(12) Patent Application Publication
(10) Pub. No.: US 2008/0044649 A1
(43) Pub. Date: Feb. 21, 2008

(54) Identification code labeling tape

(75) Inventors: Koji Fujimoto, Chiba-shi (JP); Tetsumasa Ito, Chiba-shi (JP); Tatsuya Miyatani, Chiba-shi (JP)

Correspondence Address: BRINKS HOFER GILSON & LIONE, P.O. BOX 10395, CHICAGO, IL, 60610, US

(73) Assignee: Seiko Instruments Inc., Chiba-shi (JP)

(21) Appl. No.: 11/880,389

(22) Filed: Jul. 19, 2007

(30) Foreign Application Priority Data
Jul. 19, 2006 (JP) JP2006-196632

(51) Int. Cl. B32B 3/00

(52) U.S. Cl. 428/337; 428/345

(57) ABSTRACT

An identification code labeling tape that is used by attaching to an embedding cassette for use simultaneously as a container for paraffin substitution treatment of a biological sample and as a mounting stage for mounting thereon an embedded block comprising an embedding agent having embedded therein the paraffin substituted biological sample, provided that the embedding cassette comprises a cassette body and a lid part that are fixed freely detachable and that a flat plane is formed on the surface of the cassette body, said identification code labeling tape comprising: a tape body having a color at least differing in value from the color of the cassette body; and an adhesive layer coated on the back plane of the tape body, which adheres the tape body on the flat plane; provided that the tape body displays the identification code on engraving along an irradiated laser beam.

This application claims priority under 35 U.S.C. § 119 to Japanese Patent Application No. JP2006-196632 filed Jul. 19, 2006, the entire content of which is hereby incorporated by reference.

### BACKGROUND OF THE INVENTION

1. Field of the Invention

The present invention relates to a labeling tape for displaying an identification code, which is attached to an embedding cassette that is used not only as a container for storage and substitution treatment of biological samples taken from human bodies, laboratory animals, and the like, but also as a fixing stage of embedded blocks having embedded therein the substitution treated samples.

2. Description of the Related Arts

Conventionally, a microtome has been known in general as a tool for use in preparing thin section slide samples for physicochemical experiments and microscopic observations. The thin section slides are prepared by fixing thin sections about several micrometers (for instance, from 3 μm to 5 μm) in thickness on a substrate such as a glass slide and the like. The thin sections are produced by cutting an embedded block that has been prepared by embedding biological samples in an embedding agent to an extremely thin thickness as described above. An embedded block is prepared by subjecting a formalin-fixed biological sample taken out from human bodies, laboratory animals, and the like to paraffin substitution, and then solidifying the periphery thereof with paraffin to prepare a solid block. In general, such embedded blocks are prepared utilizing a special use embedding cassette.

The embedding cassette is shaped into a box comprising a cassette body and a lid member which can be fixed in a freely detachable manner to the cassette body, and is made from a material resistant to xylene and alcohol. The cassette body and the lid member are each made from a mesh material. Thus, the inside and the outside of the embedding cassette are so constituted to communicate with each other.

The method for preparing an embedded block using the embedding cassette is briefly described below.

First, a biological sample such as an organ of an experimental animal and the like is fixed with formalin, and then cut into a proper size to be placed inside the embedding cassette. That is, the biological sample placed inside the cassette body is enclosed by attaching the lid part to the cassette body. Then, the embedding cassette is immersed into a palette filled with a chemical agent, which is alcohol in this case. In this manner, the biological sample enclosed inside the embedding cassette is immersed in alcohol so that water and lipid inside the biological sample can be replaced by alcohol; that is, the sample is subjected to dehydration and degreasing treatments. Subsequently, the chemical agent inside the palette is replaced by xylene to substitute alcohol with xylene. The chemical agent inside the palette is then substituted with liquid paraffin to further replace xylene with paraffin. In this manner, biological samples whose water and lipid are replaced by paraffin can be prepared. Then, the paraffin substituted biological samples are taken out of the embedding cassette, and are transferred into another container filled with liquid paraffin. The thus emptied cassette body is then used as the lid of the container. The paraffin inside the container is cooled and solidified in this state. In this manner, there can be prepared a paraffin embedded block having embedded therein the biological sample. In this case, the embedded block is adhered and connected to the bottom plane of the cassette body. Finally, the cassette body comprising the embedded block connected to the bottom plane is taken out of the container and reversed. As a result, there can be obtained an embedded block fixed to the bottom plane of the cassette body.

As described above, on preparing an embedded block, the embedding cassette is used not only as a container for subjecting the biological samples to the dehydration and degreasing treatment and the substitution treatment, but also as a fixing stage of the embedded block. The reason for using the embedding cassettes in two scenes in this manner is for preventing confusion or mixing up of biological samples from occurring when treating a large number of biological samples at once. In particular, since the quality control of the embedded blocks is important for carrying out accurate experiments and observations, special attention is paid concerning the mixing up and the like of the samples.

In order to accomplish accurate quality control, an identification code is recorded to the embedding cassette for recognizing the type and the like of the biological sample embedded inside the embedded block. Among various methods for recording the identification code, well known is a method for printing characters using an ink-jet printer (see for example, JP-A-2002-365184). According to this method, an identification code of desired size can be printed clearly and efficiently on the embedding cassette. As the ink for use in such a case, in general, an ink resistant to organic solvents are used by taking into consideration that the embedding cassette might be exposed to various types of chemicals.

However, the method above still had problems as below to be solved.

More specifically, the method for printing identification codes on the embedding cassettes was favorable from the viewpoint that characters and the like can be printed easily and clearly at a desired size; however, on the other hand, there were possibilities that the ink might be peeled off when the printed part was subjected to intense rubbing. In particular, inks resistant to organic solvents tended to easily peel off. Such a case of peeling off becomes a detrimental problem because an accurate quality control of the embedded block is unfeasible.

Furthermore, the conventional methods simply print the characters. Thus, the inconvenience was that if paraffin should adhere onto the printed surface during the preparation of the embedded block, the printed identification code was covered and became indiscernible. Accordingly, it was required to manually remove off the paraffin. Furthermore, there was another inconvenience that the identification code went off together with the paraffin on peeling off.

The present invention has been made under such circumstances, and an objective thereof is to provide an identification code labeling tape, which, by simply attaching it to the embedding cassette, enables engraving of the identification code by using a laser beam and displays clearly the identification code without being influenced by paraffin and free from peeling off.

### SUMMARY OF THE INVENTION

Accordingly, In order to solve the aforementioned problems, this invention provides the following solutions.

The identification code labeling tape according to the invention is an identification code labeling tape that is attached to an embedding cassette for use simultaneously as a container for paraffin substitution treatment of a biological sample and as a mounting stage for mounting thereon an embedded block comprising an embedding agent having embedded therein the paraffin substituted biological sample, provided that the embedding cassette comprises a cassette body and a lid part that are fixed freely detachable and that a flat plane is formed on the surface of the cassette body, said identification code labeling tape comprising: a tape body having a color at least differing in value from the color of the cassette body; and an adhesive layer coated on the back plane of the tape body, which adheres the tape body on the flat plane; provided that the tape body displays the identification code on engraving along an irradiated laser beam.

The identification code labeling tape according to the invention is used by attaching it to an embedding cassette which is used simultaneously as a container for paraffin substitution treatment of a biological sample and as a mounting stage for mounting thereon an embedded block comprising an embedding agent having embedded therein the paraffin substituted biological sample. On preparing an embedded block, the operator attaches first the tape body on the flat plane of the cassette body via the adhesive layer. This allows the operator to engrave in advance the necessary information of the biological sample (for instance, the type of the laboratory animal, the type or kind of the organs, and the like) as an identification code by irradiating a laser beam to the thin film layer by using a laser marker device and the like.

In particular, the method of the present invention is different from the known methods in which the identification code is simply printed, in that the tape body is graved by using a laser beam to engrave the identification code. Accordingly, the identification code is free from being rubbed off due to friction and the like which occurs during the operation of preparing the embedded block. This enables accurate quality control of the embedded block. Furthermore, the identification code can be engraved in a shorter period of time because a laser beam is used. Accordingly, the working efficiency can be improved. Moreover, since the identification code can be engraved in a non-contact manner, the identification code can be displayed irrespective of the surface roughness of the tape body. Thus, the identification code labeling tape can be produced without taking excessive care.

Further, the color of the tape body differs at least in value from that of the cassette body. Thus, the identification code that has been engraved by graving the tape body can be displayed with a value differing from that of the tape body which serves as the background color. That is, the value of the identification code can be differed from that of the background color, and thereby the identification code can be displayed by using the difference in value. For instance, an identification code can be displayed with a pale green color near to white on a dark green background color near to black. In this manner, high contrast display can be realized to assure clear visibility.

Moreover, since high visibility is assured by taking advantage of the difference in value between the identification code and the background color as described above, even if paraffin should remain to some extent on the tape body during the preparation of an embedded block, the identification code may be more clearly accepted as compared with the conventional ones. Thus, additional manual operation for shaving off paraffin can be omitted to further improve the operability.

As described in the foregoing, by simply attaching to an embedding cassette, the identification code labeling tape according to the invention enables engraving an identification code using a laser beam; hence, the identification code can be clearly displayed while preventing it from being peeled off and yet free from the effect of paraffin.

In accordance with another aspect of the invention, there is provided an identification code labeling tape as described above, wherein the color of the tape body is lower in value than the color of the embedding cassette.

In the identification code labeling tape of the invention, the color of the tape body is provided at a value lower than that of the cassette body; i.e., it is provided at a dark color near to black. Thus, the identification code can be displayed at a brighter color with respect to the dark colored background. Background color can be distinctly differed from the identification code in value, and the visibility can be further improved.

Furthermore, since the tape body can be provided at a color darker than that of the cassette body, even if white colored paraffin should adhere on the engraved identification code, the identification code appears as a further brighter pale color and thereby a high contrast can be realized. Accordingly, the visibility remains unaffected.

In accordance with a yet other aspect of the invention, there is provided an identification code labeling tape as described in one of the aspects above, wherein the cassette body is provided with a color having a value (V) as defined by JIS-Z8102 of 6.5 or higher, and the tape body is provided with a color having a value (V) as defined by JIS-Z8102 of 6.0 or lower.

In the identification code labeling tape of the invention, the tape body has a value (V) as defined by JIS-Z8102 of 6.0 or lower, for instance, beni-iro (carmine-like color; color code #D71345), shin-ryoku (deep green-like color; color code #005931), kon-ai (pale indigo-like color; color code #464A88), shikon (blue purple-like color; color code #411445), black, and the like. Furthermore, the cassette body is provided with a pale color having a value (V) of 6.5 or higher, such as sakura-iro (pale rose-like color; color code #FEEEED), flesh, green, sky blue, white, and the like. By thus enabling display of the background with a darker color while displaying the identification code with a pale color, the visibility of the identification code can be further increased by the value (or lightness) contrasting effect. In particular, it is preferred to set the color of the tape body to black, whose value (V) is 1.5, while setting the color of the cassette body to white, whose value (V) is 9.5.

According to a further aspect of the invention, there is provided an identification code labeling tape as described in any of the aspects above, wherein the tape body and the adhesive layer are each made of a material having resistances against xylene and alcohol.

In the identification code labeling tape of the invention, since the tape body and the adhesive layer are formed by a material having resistances against xylene and alcohol (for instance, polyacetal resin and a fluororesin), it remains unaffected by xylene or alcohol even in cases it is used for the biological samples in steps prior to the paraffin substitution step. Thus, the durability of the tape can be improved, and clear display of the identification code can be maintained at the same time.

In accordance with a yet other aspect of the invention, there is provided an identification code labeling tape as described in one of the aspects above, wherein the tape body has a thickness of 5 μm or more but not more than 500 μm.

Since the tape body in the identification code labeling tape according to the invention is provided at a thickness of 5 μm or more, sufficiently high strength is assured, and there is no fear of causing peeling off or defects on the tape body during or after engraving the identification code with a laser beam. The product reliability can be improved in this manner.

Furthermore, because the thickness of the tape body is not more than 500 μm, laser beams of commercially available laser marker devices (for example, carbon dioxide gas laser marker device) can easily and surely grave the tape body to engrave the identification code. If the film thickness should become thicker than this range, gravure width becomes wider as to cause deformation or blurring of the characters upon engraving.

In accordance with a further aspect of the invention, there is provided an identification code labeling tape as described in any of the aspects above, wherein the tape body is mirror finished.

In the identification code labeling tape according to the invention, the surface of the tape body is mirror finished by texturing, luster treatment, or a like treatment. Thus, this avoids paraffin adhesion on the surface during the preparation of an embedded block; or, should paraffin adhere on the surface, it can be easily removed off.

In accordance with a still other aspect of the invention, there is provided an identification code labeling tape as claimed in any of the aspects above, wherein the tape body is formed into a long ribbon-like shape, and is wound into a roll with the adhesive layer faced inward.

In the identification code labeling tape according to the invention, the tape body is formed in a long ribbon-like shape and wound into a roll, so that it can be stored in a compact state when not in use. Since the tape body is long, it can be pulled out to a necessary length and cut to easily and surely fit to the size of the embedding cassette. This makes the tape easy and convenient to use.

According to a yet other aspect of the invention, there is provided an identification code labeling tape as above, wherein dotted lines for cutting off are provided at a predetermined interval to the tape body.

In the identification code labeling tape according to the invention, by cutting the tape body along the dotted line, tape body of the same length can be easily and surely obtained regardless of the operator. Furthermore, because a dotted line for cutting off is provided, the tape body can be clean cut without any failure. Thus, the tape body can be more easily adhered to the flat plane to make it further available.

According to a still other aspect of the invention, there is provided an identification code labeling tape as described in any of the aspect of the present invention, wherein a detachable sheet formed in a sheet-like shape is provided, and plural tape bodies are provided at a predetermined length and adhered aligned to the detachable sheet in a detachable manner via the adhesive layer.

In the identification code labeling tape according to the present invention, plural tape bodies are cut at a predetermined length and adhered aligned on a detachable sheet that is formed in a sheet-like shape. Accordingly, the operator may peel off one tape body from the detachable sheet and adhere it on the flat plane of the cassette body. In this manner, any person can attach the tape body as if it were a sticker. The tape is particularly easy for use because the tape body is cut in advance into a predetermined length. Further improved in usability is that the remaining number of the tape body can be confirmed at a glance.

The identification code labeling tape according to the invention enables, by simply attaching it to the embedding cassette, engraving of the identification code by using a laser beam, which clearly displays the identification code without being influenced by paraffin and while preventing peeling off from occurring.

### BRIEF DESCRIPTION OF THE DRAWINGS

FIG. 1 is an oblique view of an identification code labeling tape according to an embodiment of the invention and an embedded block produced by using an embedding cassette;

FIG. 2a is an oblique view of an identification code labeling tape according to an embodiment of the invention and FIG. 2B is a cross section view taken along line A-A;

FIG. 3 is a plan view of an example of an embedding cassette for adhering thereon the identification code labeling tape as shown in FIG. 2;

FIG. 4 is a cross section view of the embedding cassette shown in FIG. 3;

FIG. 5 is a plan view of a cassette body constituting the embedding cassette shown in FIG. 3;

FIG. 6 is a cross section view taken along line D-D of the cassette body shown in FIG. 5;

FIG. 7 is a plan view of the lid part constituting the embedding cassette shown in FIG. 3;

FIG. 8 is a cross section view taken along line E-E of the lid part shown in FIG. 7;

FIG. 9 shows schematically a state of attaching the identification code labeling tape shown in FIG. 2 to the flat plane of the cassette body;

FIG. 10 shows schematically a state of engraving an identification code on the adhered identification code labeling tape by irradiating a laser beam to the tape body for graving;

FIG. 11 shows schematically an example of an engraved identification code;

FIG. 12 shows schematically a step for producing an embedded block by using an embedding cassette in which an identification code is engraved, in which, after enclosing therein a biological cassette embedding cassette, the embedding cassette is placed inside a palette filled with a chemical agent;

FIG. 13 shows schematically a step for producing an embedded block by using an embedding cassette in which an identification code is engraved, in which, after the state shown in FIG. 12, the biological sample subjected to paraffin substitution treatment is taken out from the cassette body and transferred into an embedding boat filled with liquid paraffin;

FIG. 14 shows schematically a step for producing an embedded block by using an embedding cassette in which an identification code is engraved, in which, after the state shown in FIG. 13, the emptied cassette body is mounted on the step part of the embedding boat;

FIG. 15 shows schematically a step for producing an embedded block by using an embedding cassette in which an identification code is engraved, in which, after the state shown in FIG. 14, paraffin is solidified to prepare the embedded block, and the cassette body is taken out from the embedding boat; and

FIG. 16 shows schematically an identification code labeling tape according to another embodiment of the invention.

### DESCRIPTION OF THE PREFERRED EMBODIMENTS

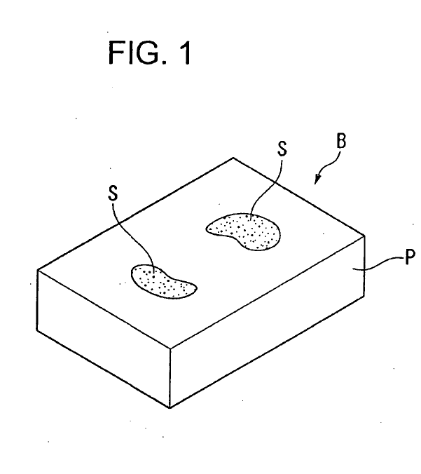

An embodiment of an identification code labeling tape according to the invention is described below by making reference to FIGS. 1 to 15.

First referring to FIG. 1, known method for inspecting and observing a biological sample S utilizing thin section slides comprises thinly cutting an embedded block B, which have been prepared by embedding the biological sample S in paraffin P as the embedding agent, into extremely thin slices 3 to 5 μm in thickness to prepare thin sections, and then fixing the thin sections on a substrate such as a glass slide.

The identification code labeling tape 1 according to the invention is used by attaching it to an embedding cassette 10, which is used simultaneously as a container for performing the paraffin substitution treatment of the biological sample S on preparing the embedded block B and as a mounting stage for mounting thereon the embedded block B.

As the biological sample S, for instance, there can be used a tissue of organs and such taken out from human bodies and laboratory animals and the like, which is properly selected depending on the fields, such as the medical, pharmaceutical, food, biological, and the like. Moreover, those samples are obtained by subjecting them to paraffin substitution treatment after the dehydration and degreasing treatments.

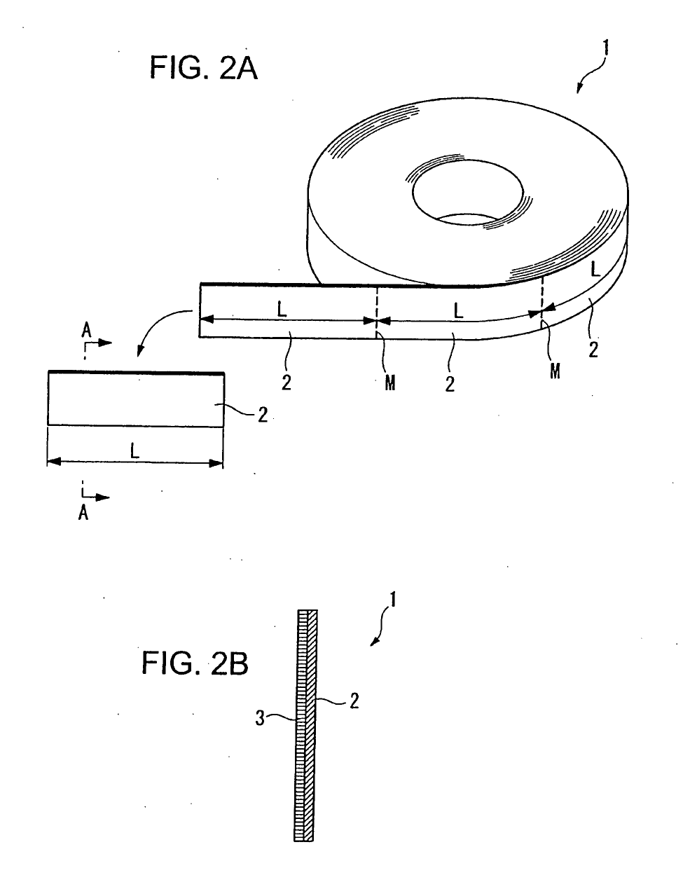

The identification code labeling tape 1 according to the present example comprises, as shown in FIGS. 2A and 2B, a tape body 2 and an adhesive layer 3 that is coated onto the back plane of the tape body 2, which adheres the tape body 2 onto the flat plane 11b of the cassette body 11, which is described hereinafter.

The tape body 2 is formed as a long ribbon-like shape, and is wound into a roll by facing the adhesive layer 3 inward. In this case, the tape body 2 is provided with dotted line M for cutting off at an interval of predetermined length L. In the present example, the dotted line M for cutting off is provided at an interval length that is approximately the same as the length of the flat plane 11b. The tape body 2 is so prepared that it displays the identification code C when graved along the laser beam L irradiated from a not shown laser marker device and the like. The details thereof are described hereinafter.

Furthermore, the tape body 2 is provided with a color at least differing in value from the color of the cassette body 11. In the present example, the tape body 2 is provided with a color lower in value than that of the cassette body 11. More specifically, the tape body 2 is provided with a color having a value (V) as defined by JIS-Z8102 of 6.0 or lower, i.e., shin-ryoku (V=3.0), and the cassette body 11 and the lid part 12 to be described hereinafter are provided with a color having a value (V) as defined by JIS-Z8102 of 6.5 or higher, i.e., green (V=6.5).

Furthermore, the tape body 2 is made from polyacetal, fluororesin, and a like material having resistances against xylene and alcohol. In addition, the thickness of the tape body 2 is controlled to fall within a range of 5 μm or more but not more than 500 μm.

Similar to the tape body 2, the adhesive layer 3 is made of an epoxy resin based material (for instance, a thermosetting thin film adhesive agent manufactured by Sumitomo 3M Limited) having excellent resistances against xylene and alcohol, and is applied entirely to the back side of the tape body 2. Since the adhesive sets in the temperature range of from 100 to 130° C., it surely fixes the cassette body 11 and the tape body (made of polyacetal having a Tm of from 165 to 170° C.) without melting.

Then, description on the embedding cassette 10 is given below.

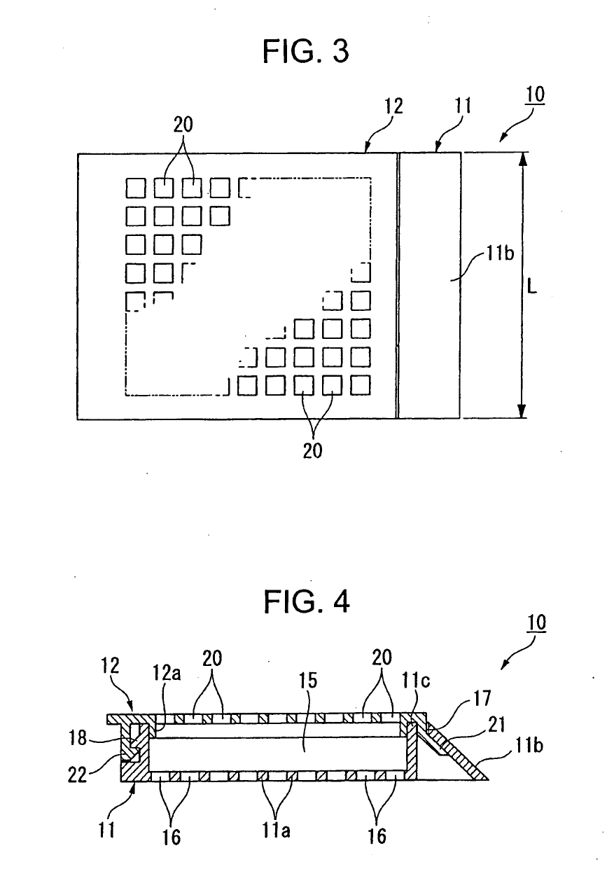

The embedding cassette 10 for use in the present example comprises, as shown in FIGS. 3 and 4, a cassette body 11 having formed thereon an open concave enclosing part 15 for placing therein the biological sample S, and a lid part 12 fixed freely detachable to the cassette body 11, which shuts the concave enclosing part 15. The cassette body 11 and the lid part 12 are made from polyacetal, fluororesin, and a like material having resistances against xylene and alcohol.

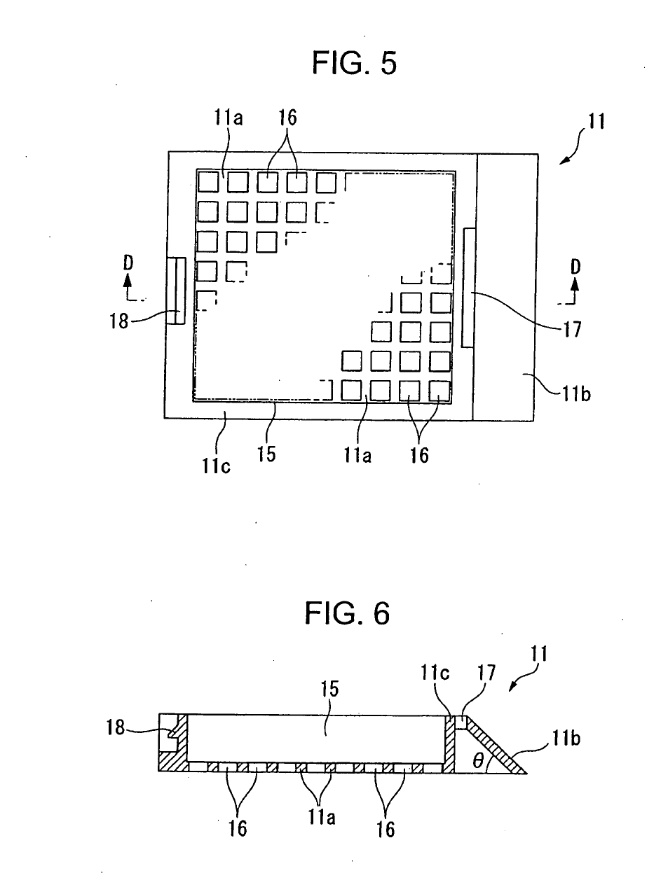

As seen in FIGS. 5 and 6 from the upper side, the cassette body 11 is formed in such a manner that they have rectangular top shapes, and the upper part corresponds to the opening of the concave enclosing part 15. In the bottom plane 11a, plural penetrating holes 16 are formed in an array-like arrangement, such that the inside and the outside of the concave enclosing part 15 may communicate with each other via the penetrating holes 16. Furthermore, a flat plane 11b, whose surface is flattened, is formed on one end of the cassette body 11 according to the present example. The flat plane 11b is provided as a slope making a predetermined angle θ with respect to the bottom plane 11a of the cassette body 11.

Furthermore, in the side wall 11c surrounding the concave enclosing part 15, an insertion hole 17 for inserting therein an engaging piece 21 of the lid part 12, which is to be stated hereinafter, is provided to the part adjacent to the flat plane 11b. Further, in the side opposed to the insertion hole 17 of the side wall 11c with the concave enclosing part 15 interposed between them, a protruded part 18 is formed, so that engaging claws 22 of the lid part 12 may be engaged thereto.

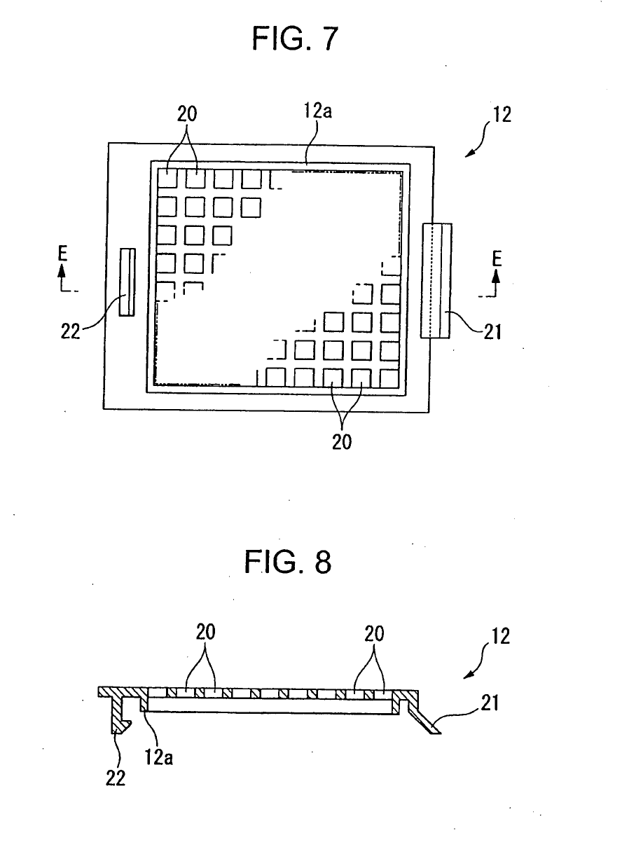

Referring to FIGS. 7 and 8, the lid part 12 is a platy member formed in such a manner that it appears as a rectangular shape as viewed from the top, and at such a size that it completely covers the side wall 11c of the concave enclosing part 15 provided to the cassette body 11. Furthermore, a step part 12a surrounding in a rectangular shape is formed on the lower plane of the lid part 12. The step part 12a is formed at such a size that it may be inside the concave enclosing part 15 of the cassette body 11 while keeping contact with the side wall 11c. Thus, in the case the lid part 12 is superposed on the cassette body 11, the step part 12a is enclosed inside the concave enclosing part 15, such that the lid part 12 may not be displaced in the horizontal direction.

In addition, similar to the case of the cassette body 11, a plurality of penetrating holes 20 formed in an array-like arrangement is provided inside the area surrounded by the step part 12a. Thus, in the case the lid part 12 is superposed on the cassette body 11, the inside and the outside of the concave enclosing part 15 can communicate with each other via the penetrating holes 20 provided to the side of the lid part 12.

Furthermore, as described above, to the lower plane of the lid part 12 is provided an engaging piece 21 to be inserted into the insertion hole 17 provided to the cassette body 11, which has an engaging claw 22 that engages with the protruded part 18 of the cassette body 11 upon insertion. The engaging piece 21 is so formed that it may protrude from one end at approximately the same angle θ as that made by the bottom plane 11a and the flat plane 11b of the cassette body 11, and after it is inserted into the insertion hole 17, the plane thereof is brought into contact with the back side of the flat plane 11b in such a manner that the lid part 12 may be positioned. Further, the engaging claw 22 is formed on the lower plane in such a manner that it is protruded in a direction approximately perpendicular to the lower plane of the lid part 12, and has a hooked front end so that it may be hooked and engaged with the protruded part 18.

As described above, the lid part 12 is so designed that, by using the step part 12a and the engaging piece 21, it may be superposed to a predetermined position with respect to the cassette body 11 and attached to the cassette body 11 at the same time by engaging the engaging claws 22 with the protruded part 18.

Then, the case of producing an embedded block B using the identification code labeling tape 1 and the embedding cassette 10 above, is described below.

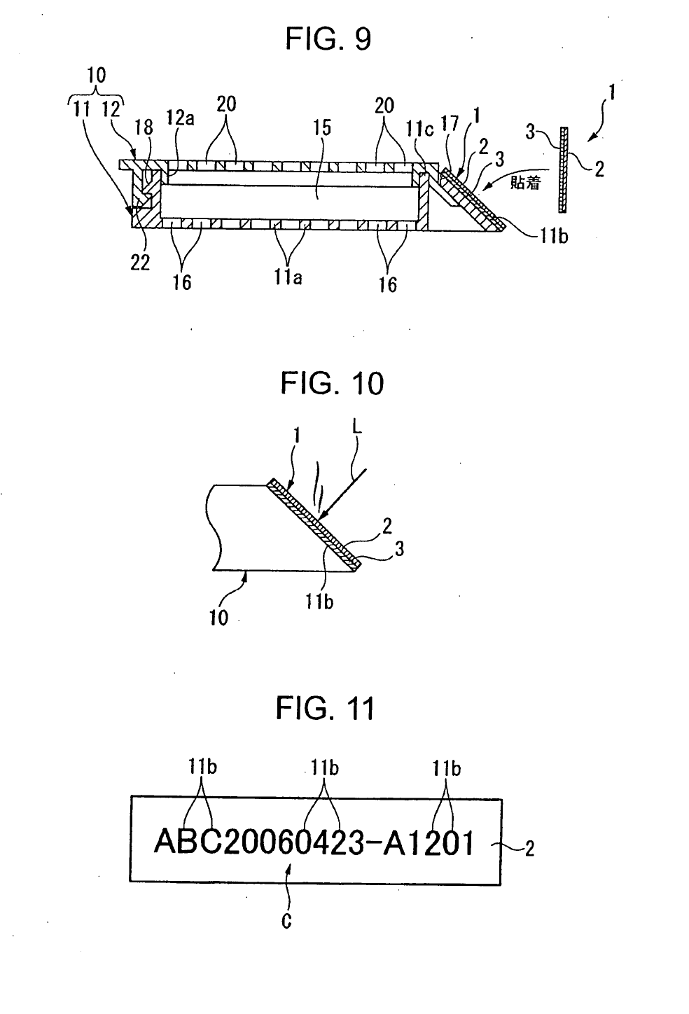

First, the operator prepares a formalin fixed biological sample S and an embedding cassette 10 for enclosing the biological sample S at the same time as shown in FIGS. 3 and 4. Subsequently, the operator attaches the identification code labeling tape 1 on the flat plane 11b of the cassette body 11. More specifically, the tape body 2 wound in a roll is drawn out, and the tape body is cut along the dotted line M. In this manner, a tape body having approximately the same length L as the length of the flat plane 11b of the cassette body 11 can be obtained. Then, as shown in FIG. 9, the tape body 2 is adhered to the flat plane 11b of the cassette body 11 via the adhesive layer 3 by heating it in a temperature range of from 100 to 130° C.

Subsequently, the operator conducts an operation for displaying, on the embedding cassette 10, the necessary information related to the biological sample S, such as the type of the laboratory animal, the type or kind of the organs, and the like, as an identification code C. More specifically, as shown in FIG. 10, a commercially available laser marker device and the like is used to irradiate laser beam L onto the adhered tape body 2. Then, the tape body 2 is graved along the laser beam L. In this manner, as shown in FIG. 11, necessary information is engraved on the embedding cassette 11 as an identification code C (ABC20060423-A1201).

After the identification code C is engraved, the lid part 12 is detached from the cassette body 11. Then, after cutting the biological sample S corresponding to the engraved identification code C into a proper size, the biological sample S is enclosed inside the concave enclosing part 15 of the cassette body 11. Subsequent to the enclosure, the lid part 12 is attached to the cassette body 11 to enclose the biological sample S therein. That is, while keeping the engaging piece 21 of the lid part 12 inside the insertion hole 17 of the cassette body 11, the lid part 12 is gradually superposed to the cassette body 1. In this manner, the step part 12a of the lid part 12 gradually enters from the engaging piece 21 side to the inside of the concave enclosing part 15 of the cassette body 11. By thus positioning the lid part 12, the lid part 12 can be accurately superposed on the cassette body 11. Finally, the engaging claws 22 of the lid part 12 is engaged with the protruded part 18 of the cassette body 11 to surely attach the lid part 12 onto the cassette body 11 and close the opening of the concave enclosing part 15.

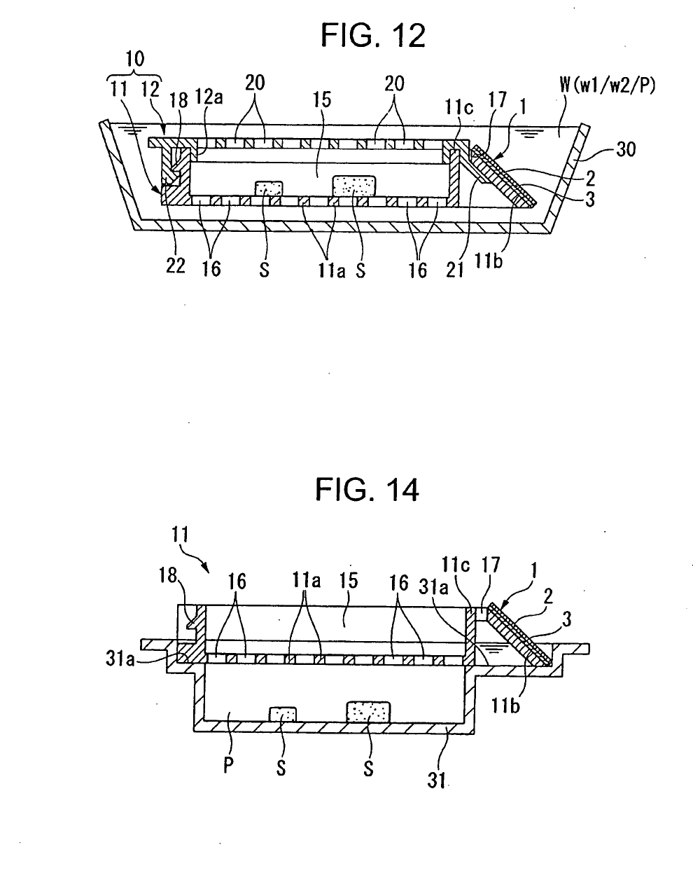

After enclosing the biological sample S, the biological sample S is subjected to paraffin substitution treatment. First, as shown in FIG. 12, the embedding cassette 10 is immersed in alcohol w1, which is a chemical W, filled in a palette 30. In this case, since the inside of the concave enclosing part 15 is communicated with the outside via the penetrating holes 16 and 20 each formed in the cassette body 11 and the lid part 12, the alcohol w1 flows into the concave enclosing part 15. Accordingly, the inner water and lipid of the biological sample S are substituted by alcohol w1, i.e., the sample S undergoes dehydration treatment and degreasing treatment.

Subsequently, the chemical W inside the palette 30 is replaced by xylene w2, to thereby substitute the previously substituted alcohol w1 with xylene w2. Finally, the chemical W inside the palette 30 is replaced by liquid paraffin P. In this manner, a biological sample S whose water and lipid are substituted by paraffin can be prepared.

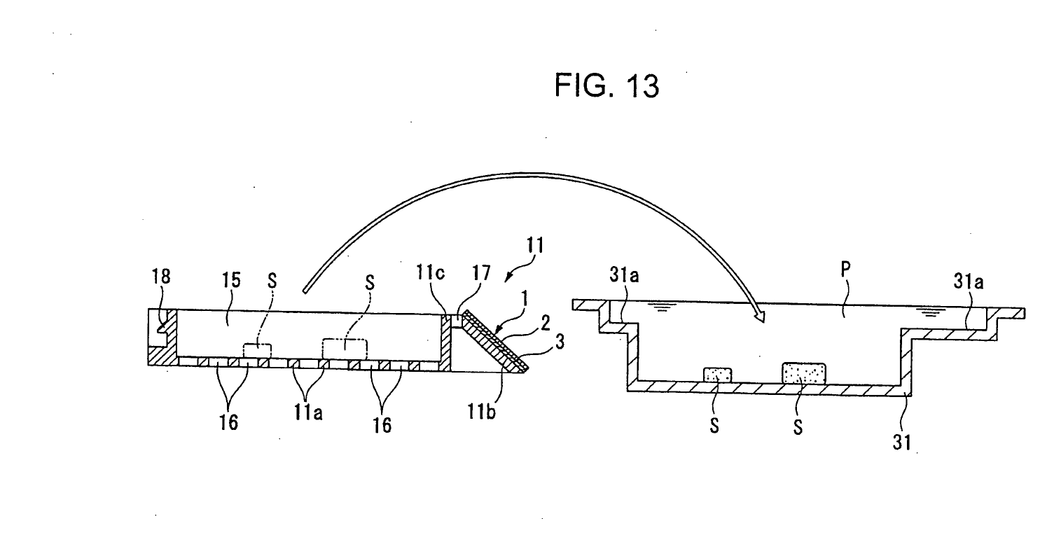

Upon completion of the operation of paraffin substitution, the lid part 12 is detached from the cassette body 11 as shown in FIG. 13. In addition, an embedding boat 31 having a step part 31a and filled with liquid paraffin P is prepared. Then, at the same time with the biological sample S is taken out from the concave enclosing part 15 of the cassette body 11, the thus taken out biological sample S is enclosed inside the embedding boat 31 so that it may be immersed in paraffin P. Simultaneously, as shown in FIG. 14, the vacant cassette body 11 is mounted on the step part 31a of the embedding boat 31 to cap the embedding boat 31. In this case, the amount of paraffin P is so adjusted that the paraffin P may enter inside the concave enclosing part 15 formed in the cassette body 11. The embedding boat 31 is cooled in this state to cool and solidify the paraffin P.

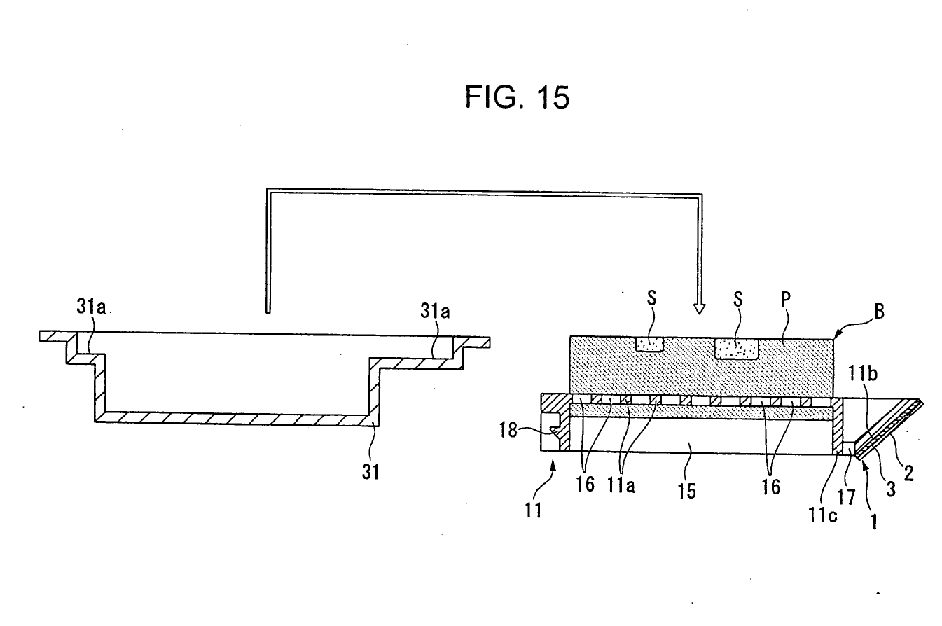

In this manner, an embedded block B having embedded therein the biological sample S can be prepared. In this case, the embedded block B is adhered and connected to the bottom plane 11a of the cassette body 11. Finally, as shown in FIG. 15, the cassette body 11, to which the embedded block B is connected by the bottom plane 11a, is taken out from the embedding boat 31 and reversed. As a result, a solidified embedded block B can be obtained on the bottom plane 11a of the cassette body 11.

As described in the foregoing, in the case of preparing the embedded block B, the embedding cassette 10 is used as a container for the paraffin substitution treatment of the biological sample S, and as a mounting stage of the embedded block B. Thus, because the embedding cassette 10 is used in two scenes, even if large number of biological samples S should be treated at once, the confusion among the biological samples S can be prevented from occurring. Furthermore, since the identification code C relevant to the biological sample S can be displayed by using the tape body 2 adhered to the cassette body 11, accurate quality control can be performed.

In particular, differing from a conventional method in which an identification code C is simply printed, the present invention utilizes a laser beam L to grave the tape body 2 to engrave the identification code C; thus, the identification code C cannot be peeled off due to friction and the like that may occur during the preparation of the embedded block B. Accordingly, the quality control of the embedded block B can be carried out accurately.

In addition, the operation can be completed in a shorter period of time because the identification code C can be engraved by using a laser beam L. Thus, the operation efficiency can be improved. Furthermore, because the identification code C can be engraved in a non-contact manner, the identification code C can be displayed irrespective of the surface roughness of the tape body 2. Accordingly, the tape body 2 can be formed without taking excessive care.

The color of the tape body 2 differs at least in value from that of the cassette body 11. Thus, the identification code C engraved by graving the tape body 2 can be displayed at a color with a value differing from that of the tape body 2 which serves as the background color. Accordingly, the brightness of the identification code C and the background color can be changed, and thereby the identification code C can be displayed by using the difference in value. In this manner, high contrast display can be realized to assure clear visibility.

In particular, in the case of the present example, the tape body 2 is provided as shin-ryoku (deep green-like) color against green color of the cassette body 11. That is, the color of the tape body 2 is a darker color near to black as compared with the color of the cassette body 11. In this manner, the identification code C can be displayed at a color brighter than the background color provided with a dark color. Thus, a distinct value difference can be given between the background color and the identification code C to further improve the visibility. Moreover, since shin-ryoku has a value (V) of 3.0 and green has a value (V) of 6.5, a clearer contrast is attained by the contrasting effect. Thus, the identification code C can be more clearly displayed and easily discerned.

Furthermore, should paraffin P remain to some extent on the tape body 2 during the preparation of the embedded block B, as described above, since high visibility of the identification code C is assured by taking advantage of the value difference between the identification code C and the background color, the identification code C can be more clearly observed as compared with the conventional cases. Accordingly, the additional manual operation for shaving off paraffin may be omitted so as to further improve the operability. In addition, should paraffin P be shaved off, the identification code C is engraved, so differently from the conventional cases, it remains without being peeled off.

Furthermore, even if a white-colored paraffin P adheres to the engraved identification code C, the identification code C is further contrasted because it is provided at a brighter pale color. Thus, the visibility remains unaffected.

The tape body 2 and the cassette body 11 according to the present example are both formed by a material having resistances against xylene and alcohol. Thus, they are unaffected by xylene or alcohol used for the paraffin substitution treatment. Thus, the durability is improved and a clear display of the identification code C is maintained.

In addition, since the tape body 2 according to the present example is provided at a film thickness of 5 μm or more, sufficiently high strength is assured. Thus, there are no possibilities of generating peeling off or defects on the tape body 2 during or after engraving the identification code C by using the laser beam L. Thus, the reliability of the product can be improved. Furthermore, since the tape body 2 should be formed at a film thickness of 500 μm or less, the laser beam L emitted by any commercially available laser marker device (for example, carbon dioxide gas laser marker device) can be utilized to easily and surely grave the tape body 2 to engrave the identification code C. On the other hand, should the film thickness exceed the range above, the line becomes wider to deform or blur the engraved characters.

Moreover, since dotted lines M for cutting off are provided to the tape body 2 according to the present example, tape bodies 2 of the same length can be easily and surely obtained by cutting the tape body 2 along the dotted line, regardless of the operator. Furthermore, because the dotted line M for cutting off is provided, the tape body 2 can be clean cut free of failures. Thus, the tape body can be more easily adhered to the flat plane to make it further available. In addition, since the tape body is wound into a roll, it can be stored in a compact manner.

The technical range of the present invention is not only limited to the example above, and various modifications may be made so long as they do not deviate from the scope of the invention.

For instance, the surface of the tape body 2 may be mirror finished by texturing, luster treatment, or a like treatment. In this manner, the adhesion of paraffin P onto the surface of the tape body 2 may be further prevented from occurring, or should paraffin P adhere on the surface, the paraffin P can be more easily taken off.

In the example above, the color of the tape body 2 was set to shin-ryoku, and the cassette body 11 was provided with green color, but the combination of the colors is not only limited thereto. Colors at least differing in value may be freely selected. However, preferred is to select a color having a value (V) as defined by JIS-Z8102 of 6.0 or lower for the tape body 2, and to select a color with value (V) or 6.5 or higher for the cassette body 11. Among such colors, more preferred is to use black having a value (V) of 1.5 for the tape body 2, and to use white having a value (V) of 9.5 as the cassette body 11.

In addition, in the example above, the flat plane 11b was provided as a slope, but the invention is not only limited thereto, and so long as it is formed on the surface of the cassette body 11, it need not be a slope and may be provided at any position.

Furthermore, in the example above, the tape body 2 was wound into a roll, but it is not limited thereto.

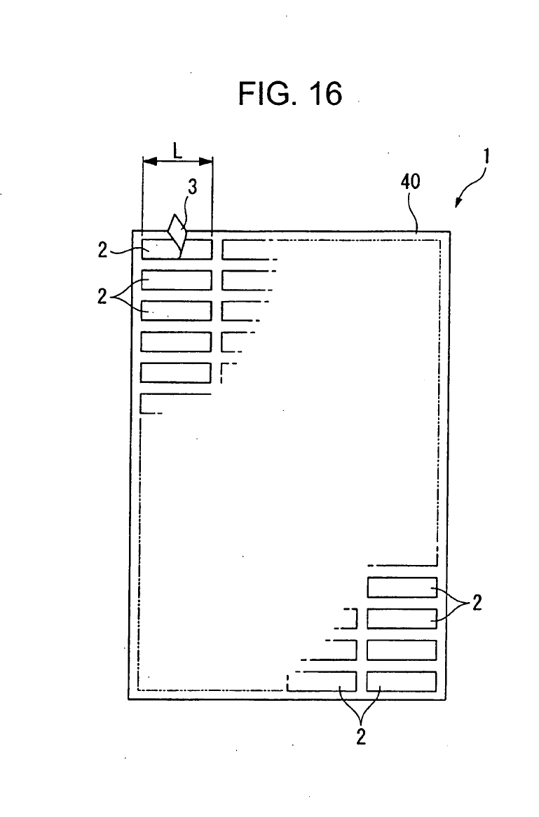

For instance, as shown in FIG. 16, the identification code labeling tape 1 may be further equipped with a sheet-like formed detachable sheet 40, so that plural tape bodies 2 may be aligned at a predetermined interval length L and provided detachable on the detachable sheet 40 via the adhesive layer 3.

In the case of using the identification code labeling tape 1 of such a constitution, the operator may peel off one tape body 2 from the detachable sheet 40 and adhere it on the flat plane 11b of the cassette body 11. In this manner, any person can attach the tape body 2 as if it were a sticker. The tape body 2 is particularly easy for use because it is cut in advance into a predetermined length L. Further improved in usability is that the remaining number of the tape bodies 2 can be confirmed at a glance.

What is claimed is:

1. An identification code labeling tape that is attached to an embedding cassette for use simultaneously as a container for paraffin substitution treatment of a biological sample and as a mounting stage for mounting thereon an embedded block comprising an embedding agent having embedded therein the paraffin substituted biological sample, provided that the embedding cassette comprises a cassette body and a lid part that are fixed freely detachable and that a flat plane is formed on the surface of the cassette body, said identification code labeling tape comprising:
a tape body having a color at least differing in value from the color of the cassette body; and
an adhesive layer coated on the back plane of the tape body, by which the tape body is adhered on the flat plane;
provided that the tape body displays the identification code on engraving along an irradiated laser beam.

2. An identification code labeling tape as claimed in claim 1,
wherein the tape body is provided with a color having a lower value than the color of the embedding cassette.

3. An identification code labeling tape as claimed in claim 2,
wherein the cassette body is provided with a color having a value (V) as defined by JIS-Z8102 of 6.5 or higher, and
the tape body is provided with a color having a value (V) as defined by JIS-Z8102 of 6.0 or lower.

4. An identification code labeling tape as claimed in claim 1, wherein
the tape body and the adhesive layer are each made of a material having resistances against xylene and alcohol.

5. An identification code labeling tape as claimed in claim 1, wherein
the tape body has a thickness of 5 μm or more but not more than 500 μm.

6. An identification code labeling tape as claimed in claim 1, wherein
the tape body has a mirror finished surface.

7. An identification code labeling tape as claimed in claim 1, wherein
the tape body is formed into a long ribbon-like shape, and is wound into a roll with the adhesive layer faced inward.

8. An identification code labeling tape as claimed in claim 7, wherein
dotted lines for cutting off are provided at a predetermined interval to the tape body.

9. An identification code labeling tape as claimed in claim 1, wherein
a detachable sheet formed in a sheet-like shape is provided, and
plural tape bodies are provided at a predetermined length and adhered aligned to the detachable sheet in a detachable manner via the adhesive layer.
